(19) United States
(12) Patent Application Publication
(10) Pub. No.: US 2005/0057520 A1
(43) Pub. Date: Mar. 17, 2005

(54) Data input device with communications interface

(76) Inventor: Robert J. Robinson, Jamison, PA (US)

Correspondence Address: Roberts & Mercanti, L.L.P., P.O. Box 484, Princeton, NJ, 98542, US

(21) Appl. No.: 10/665,384

(22) Filed: Sep. 17, 2003

(51) Int. Cl. G09G 5/00

(52) U.S. Cl. 345/169

(57) ABSTRACT

A data input device including a cartridge having an outer surface, a data input element such as a keyboard on the outer surface of the cartridge, and a communications interface within the cartridge. The cartridge is designed to be matedly and removably attachable to a hand held electronic data organizer such that when the data input device is attached to the organizer, both the data input element and the communications interface are electrically connected to a microprocessor of the organizer. Thus, upon attachment, the data input element is capable of inputting data into the microprocessor and the communications interface is capable of transmitting data between the microprocessor and a telecommunications network.

### BACKGROUND OF THE INVENTION

1. Field of the Invention

The present invention relates to portable electronic data processing devices. More particularly, the invention relates to a data input device including a combination data input element and a communications interface, such as a modem or the like, which data input device is attachable to an electronic data processing device such as a hand held data organizer or personal digital assistant.

2. Description of the Related Art

Portable data processing devices that assist with processing and information needs include personal digital assistants (PDAs), data organizers, and the like. PDA's are small devices, typically smaller than a notebook computer, which store personal information and also may serve as an interface to telecommunications networks. They typically include a means for data input, a data processing means, a display, and optional telecommunications capabilities. PDAs, which are much more versatile hand held computers, are often characterized by a relatively large touch sensitive screen which serves as both an input and output interface.

Data organizers are typically smaller yet than PDA's, and are able to receive, store, process, and display certain types of alphanumeric information. Typically, they are used for keeping track of phone numbers, addresses, appointments, and the like. While data organizers can be thought of as computers, they hold a separate niche in the market because of their smaller size and special operating system.

PDA's and data organizers typically include one or several means of expanding their functionality by adding or connecting to external peripheral components. This may be accomplished by means of connecting peripheral devices to built-in data ports, establishing an IRDA or RF wireless link to peripheral devices or by component card slots designed to accommodate peripheral components. Where component card slots are utilized, typically one or two slots are available for the removable attachment of peripheral components. Typically, one slot is used for attachment to a telecommunications device, and another slot is used for the attachment of a data input device, such as a, keypad or the like. With the advent of additional desirable peripheral components in this field, the need has arisen for data organizers to be attachable to several peripheral components at the same time. However, due to size and cost constraints, it would be difficult or impossible to design conventional data organizers to include more than one or two of such component card slots. It would therefore be desirable to provide a data input device which includes both a data input element and a communications interface. The present invention provides a solution to this problem.

The invention relates to a data input device which includes a cartridge having an outer surface, a data input element such as a keyboard on the outer surface of the cartridge, and a communications interface within the cartridge. The cartridge is designed to be matedly and removably attachable to a data port, or the like, of a hand held electronic data organizer such that when the data input device is attached to the organizer, both the data input element and the communications interface are electrically connected to a microprocessor of the organizer. Thus, upon attachment, the data input element is capable of inputting data into the microprocessor and the communications interface is capable of transmitting data between the microprocessor and a telecommunications network.

### SUMMARY OF THE INVENTION

The invention provides a multi-component electronic device which comprises:
a) a display component, comprising a housing having an exterior surface; a microprocessor within the housing; a data memory within the housing, which data memory is electrically coupled to the microprocessor; a data display on the external surface of the housing, which data display is electrically coupled to the microprocessor and the data memory; and a first electrical connector coupled to the microprocessor, the data memory and the data display; and
b) a data input component, comprising a cartridge having an outer surface, a data input element on the outer surface of the cartridge; and a communications interface within the cartridge; wherein the cartridge comprises a second electrical connector which is matedly and removably attachable to the display component via the first electrical connector such that when the first electrical connector is attached to the second electrical connector, both the data input element and the communications interface are electrically connected to the microprocessor, and wherein the data input element is capable of inputting data into the microprocessor and the communications interface is capable of transmitting data between the microprocessor and a telecommunications network.

The invention also provides a data input device comprising a cartridge having an outer surface, a data input element on the outer surface of the cartridge; and a communications interface within the cartridge; wherein the cartridge comprises a second electrical connector which is matedly and removably attachable to a first electrical connector of a hand held electronic data organizer such that when the data input device is attached to the hand held electronic data organizer, both the data input element and the communications interface are electrically connected to a microprocessor of the hand held electronic data organizer, and wherein the data input element is capable of inputting data into the microprocessor and the communications interface is capable of transmitting data between the microprocessor and a telecommunications network.

The invention further provides a method for processing data which comprises:
I) providing a multi-component electronic device which comprises:
   a) a display component, comprising a housing having an exterior surface; a microprocessor within the housing; a data memory within the housing, which data memory is electrically coupled to the microprocessor; a data display on the external surface of the housing, which data display is electrically coupled to the microprocessor and the data memory; and a first electrical connector coupled to the microprocessor, the data memory and the data display; and
   b) a data input component, comprising a cartridge having an outer surface, a data input element on the outer surface of the cartridge; and a communications interface within the cartridge; wherein the cartridge comprises a second electrical connector which is matedly and removably attachable to the display component via the first electrical connector such that when the first electrical connector is attached to the second electrical connector, both the data input element and the communications interface are electrically connected to the microprocessor, and wherein the data input element is capable of inputting data into the microprocessor and the communications interface is capable of transmitting data between the microprocessor and a telecommunications network;
II) inputting data and function commands into the microprocessor of the display component via the data input element of the removable data input component;
III) processing the entered data via the microprocessor; and
IV) displaying the processed data via the data display.

### BRIEF DESCRIPTION OF THE DRAWINGS

FIG. 1 shows a front view of a multi-component electronic device which includes a data input device of the invention.

FIG. 2 shows a front view of a data input device of the invention.

FIG. 3 shows a rear view of a data input device of the invention.

### DETAILED DESCRIPTION OF THE PREFERRED EMBODIMENT

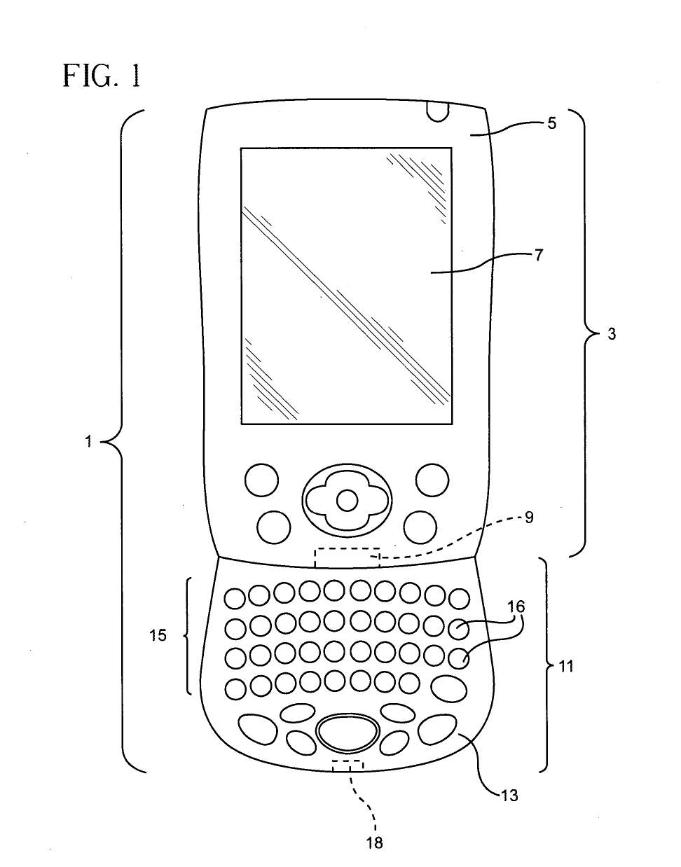

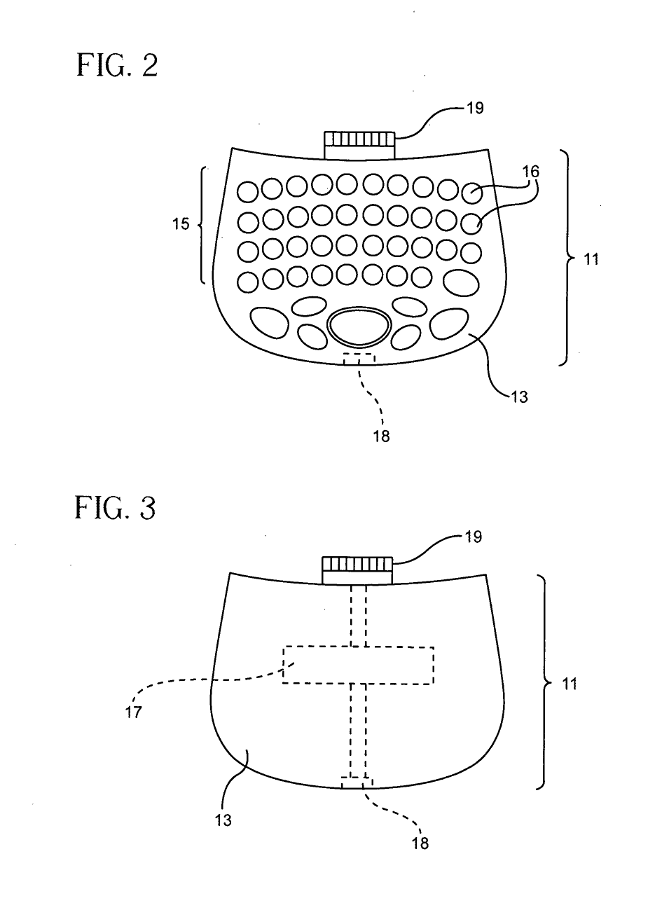

The invention provides a data input device 11 which is shown in FIGS. 1, 2, and 3. Hereinafter the terms “data input device” and “data input component” are used interchangeably. FIG. 1 shows the data input device 11 as a component of a multi-component electronic device 1. FIGS. 2 and 3 show a front and rear view, respectively, of a data input device 11 of the invention.

The invention provides a multi-component electronic device 1. The multi-component electronic device 1 includes a display component 3 and a data input component 11.

The display component 3 may comprise any suitable electronic data device such as a hand held electronic data organizer or PDA, or the like and may be purchased commercially.

The display component 3 includes a housing 5 having an exterior surface. The housing 5 serves as a protective structure for encasing various internal components of the display component such as a microprocessor, calculator chip, electronic circuitry, display backlighting, and the like. The housing 5 may comprise plastic, metal, rubber, and the like, or combinations thereof, or any other material which one skilled in the art may deem suitable for forming a protective structure. In a preferred embodiment, the housing comprises a plastic material.

The display component also includes a microprocessor within the housing 5. The microprocessor is preferably electrically coupled via internal wires within the housing to the data display 7, as well as other internal components described below. The microprocessor serves to process data which has been entered via the data input component 11, such that the processed data may be visually displayed by the data display 7. Examples of functions which may be performed by the microprocessor nonexclusively include numeric calculator functions, graphing functions, mapping functions, data organization functions, and word functions such as word processing and spread sheets. The microprocessor may also be capable of spell checking, thesaurus, and language translation functions, and the like.

The microprocessor is preferably also electrically connected to an internal power source within the housing 5. The power source may comprise any conventional power supplying means known in the art. Preferably, the power source comprises a battery, a solar cell, a miniature fuel cell or the like. The power source preferably comprises a battery located within the housing 5, and which battery is electrically connected via internal wires to the microprocessor. In a most preferred embodiment, power is supplied to the data display 7 and the data memory from an internal battery via the microprocessor.

The display component further includes an internal data memory within the housing 5. The data memory is capable of receiving and storing data such as numeric data and/or alphanumeric data and the like. The data memory is preferably electrically coupled to the microprocessor via internal wires within the housing. Such data memories are well known in the art.

The display component 3 also includes a data display 7 on the external surface of the housing 5, as shown in FIG. 1. The data display 7 is electronically connected to the microprocessor and the data memory, and serves to visually display data which has been stored by the data memory and/or processed by the microprocessor. The data display 7 may comprise any known conventional means for visually displaying data, such as a black and white or color screen. In a most preferred embodiment, the data display 7 comprises a liquid crystal display (LCD) as shown in FIG. 1. Other known displays nonexclusively include light-emitting diode displays, backlighted screen displays, and the like. Such are well known in the art.

The microprocessor, data display, and data memory are all well known in the art such as from U.S. Pat. Nos. 5,625,673, 5,818,924 and 5,548,477 which are incorporated herein by reference.

The display component 3 further includes a first electrical connector 9 which is internally electrically coupled to the microprocessor, the data memory and the data display. The first electrical connector 9 may comprise any suitable male-type connector such as a plug, or female-type connector such as a socket or port. Preferably, the first electrical connector 9 comprises a female-type connector such as an input/output port. Most preferably, the first electrical connector 9 comprises a data port which is capable of transferring electronic signals and the like. Examples of such data ports nonexclusively include serial, USB, parallel, IRDA, RF and other suitable data ports and the like. It is known in the art for electronic data devices such as a hand held electronic data organizers to comprise one or more such data ports.

As shown in FIG. 1, a data input component 11 is removably attached to the display component 3. The data input component 11 includes a cartridge 13 having an outer surface, a data input element 15 on the outer surface of the cartridge, and a communications interface 17 within the cartridge 13.

Like the housing 5 of the display component 3, the cartridge 13 of the data input component 11 serves as a protective structure for encasing various internal components of the data input component such as the communications interface, electronic circuitry, and the like. The cartridge 13 may comprise plastic, metal, rubber, and the like, or combinations thereof, or any other material which one skilled in the art may deem suitable for forming a protective structure. It is preferred that the cartridge 13 comprises substantially the same material as the housing 5. However, the cartridge 13 may comprise a material which is substantially the same or different from the material of the housing 5. In a preferred embodiment, the cartridge comprises a plastic material.

The data input element 15 is capable of inputting data and/or function commands into a microprocessor which is present within the housing 5, as described below. The data input element 15 may comprise any conventional data inputting means known to those skilled in the art such as a keypad, a touch screen, and the like. FIGS. 1 and 2 shows a preferred embodiment wherein the data input element 15 comprises a keypad having least one depressible key or button 16 for inputting data into the microprocessor. In an alternate embodiment, data may be entered into the microprocessor by touching a touch screen with a pen or stylus.

A key feature of the present invention is the presence of the communications interface 17 within the cartridge 13. The communications interface 17 serves to transmit data between the microprocessor of the display component 3 and a telecommunications network or the like. Suitable examples of communications interfaces nonexclusively include wireless or wired communication devices for connecting to LANs, WANs and the like. Other suitable examples of communications interfaces nonexclusively include WiFi connections, and 802.11 connections. Preferably, the communication interface comprises a wireless or wired modem. In a most preferred embodiment the communications interface 17 comprises a wireless modem. Such are well known in the art. Typically, a wireless modem comprises an antenna, a receiver for receiving inbound data, an internal processor for processing data, a memory storage component for storing data, and a transmitter for transmitting outbound data. Conventional wireless modems are described, for example, in U.S. Pat. No. 6,151,355, U.S. Pat. No. 5,592,491 and U.S. Pat. No. 5,864,580 which are incorporated herein by reference.

In another embodiment, the communications interface comprises a socket 18 for wired connection to a telecommunications network such as via a standard telephone jack.

The cartridge 13 also comprises a second electrical connector 19 which is internally electrically coupled to the data input element 15 and the communications interface 17. The second electrical connector is matedly and removably attachable to the first electrical connector 9 of the display component 3. The second electrical connector 19 may comprise any suitable male-type connector such as a plug, or female-type connector such as a socket or data port or the like. Preferably, the second electrical connector 19 comprises a male-type connector such as a data input/output card or the like which is capable of transferring electronic signals and the like.

The connectors may be connected directly, for example directly to each other, or indirectly, for example via a wire. It is preferred that the first and second connectors are directly connected to each other in a male-female configuration. Most preferably, the first connector comprises a female connector and the second connector comprises a male connector.

According to this configuration both the data input element 15 and the communications interface 17 are electrically connected to the microprocessor such that the data input element 15 is capable of inputting data into the microprocessor and the communications interface 17 is capable of transmitting data between the microprocessor and a telecommunications network.

The invention also provides a method for processing data. In the practice of the present invention, a multi-component electronic device is provided as described above. Preferably, a user connects the data input component to the display component by manually inserting a male component of the second electrical connector 19 into a female component of the first electrical connector 9. Data and function commands are then entered into the microprocessor of the display component via the data input element of the removable data input component. This preferably includes typing such data and function commands into the microprocessor via a keypad. The entered data is then processed by the microprocessor and is then displayed via the data display.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A multi-component electronic device which comprises:
a) a display component, comprising a housing having an exterior surface; a microprocessor within the housing; a data memory within the housing, which data memory is electrically coupled to the microprocessor; a data display on the external surface of the housing, which data display is electrically coupled to the microprocessor and the data memory; and a first electrical connector coupled to the microprocessor, the data memory and the data display; and
b) an input component, comprising a cartridge having an outer surface, a data input element on the outer surface of the cartridge; and a communications interface within the cartridge; wherein the cartridge comprises a second electrical connector which is matedly and removably attachable to the display component via the first electrical connector such that when the first electrical connector is attached to the second electrical connector, both the data input element and the communications interface are electrically connected to the microprocessor, and wherein the data input element is capable of inputting data into the microprocessor and the communications interface is capable of transmitting data between the microprocessor and a telecommunications network.

2. The electronic device of claim 1 wherein the first connector comprises a data port.

3. The electronic device of claim 1 wherein the second connector comprises a data port.

4. The electronic device of claim 1 wherein the data input element comprises a keypad.

5. The electronic device of claim 1 wherein the data input element comprises a touch screen.

6. The electronic device of claim 1 wherein the data display comprises a liquid crystal display or a light emitting diode display.

7. The electronic device of claim 1 which comprises a hand held electronic data organizer.

8. The multi-component electronic device of claim 1 wherein the communications interface comprises a modem.

9. A data input device comprising a cartridge having an outer surface, a data input element on the outer surface of the cartridge; and a communications interface within the cartridge; wherein the cartridge comprises a second electrical connector which is matedly and removably attachable to a first electrical connector of a hand held electronic data organizer such that when the data input device is attached to the hand held electronic data organizer, both the data input element and the communications interface are electrically connected to a microprocessor of the hand held electronic data organizer, and wherein the data input element is capable of inputting data into the microprocessor and the communications interface is capable of transmitting data between the microprocessor and a telecommunications network.

10. The data input device of claim 9 wherein the first connector comprises a data port.

11. The data input device of claim 9 wherein the second connector comprises a data port.

12. The data input device of claim 9 wherein the data input element comprises a keypad.

13. The data input device of claim 9 wherein the data input element comprises a touch screen.

14. The data input device of claim 9 wherein the communications interface comprises a modem.

15. A method for processing data which comprises:
I) providing a multi-component electronic device which comprises:
a) a display component, comprising a housing having an exterior surface; a microprocessor within the housing; a data memory within the housing, which data memory is electrically coupled to the microprocessor; a data display on the external surface of the housing, which data display is electrically coupled to the microprocessor and the data memory; and a first electrical connector coupled to the microprocessor, the data memory and the data display; and
b) an input component, comprising a cartridge having an outer surface, a data input element on the outer surface of the cartridge; and a communications interface within the cartridge; wherein the cartridge comprises a second electrical connector which is matedly and removably attachable to the display component via the first electrical connector such that when the first electrical connector is attached to the second electrical connector, both the data input element and the communications interface are electrically connected to the microprocessor, and wherein the data input element is capable of inputting data into the microprocessor and the communications interface is capable of transmitting data between the microprocessor and a telecommunications network;
II) inputting data and function commands into the microprocessor of the display component via the data input element of the removable input component;
III) processing the entered data via the microprocessor; and
IV) displaying the processed data via the data display.

16. The method of claim 15 which further comprises transmitting data between the microprocessor and a telecommunications network via the communications interface.

17. The method of claim 15 wherein the first connector comprises a data port.

18. The method of claim 15 wherein the second connector comprises a data port.

19. The method of claim 15 wherein the data input element comprises a keypad.

20. The method of claim 15 wherein the data input element comprises a touch screen.

21. The method of claim 15 wherein the data display comprises a liquid crystal display or a light emitting diode display.

22. The method of claim 15 wherein the multi-component electronic device comprises a hand held electronic data organizer.

23. The method of claim 15 wherein the communications interface comprises a modem.
